(19) United States
(12) Patent Application Publication
(10) Pub. No.: US 2023/0031959 A1
(43) Pub. Date: Feb. 2, 2023

(54) FEMALE TERMINAL, CONNECTOR AND WIRING HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Teruyoshi MUNEKATA, Mie (JP); Hiromu OTANI, Mie (JP)

(21) Appl. No.: 17/786,991

(22) PCT Filed: Dec. 11, 2020
(86) PCT No.: PCT/JP2020/046258

§ 371 Date: Jun. 17, 2022

(30) Foreign Application Priority Data
Dec. 26, 2019 (JP) 2019-237239

(51) Int. Cl. H01R 13/11; H01R 13/03

(52) U.S. Cl. CPC H01R 13/11; H01R 13/03

(57) ABSTRACT

A female terminal is provided with a tube portion and a spring piece to be arranged inside the tube portion. The tube portion has an opening end, through which a male terminal is inserted, and a first inner surface and a second inner surface facing each other across the spring piece. The spring piece is cantilevered and supported on the first inner surface. The spring piece has a front side region configured to face the male terminal, a back side region to be arranged on the side of the first inner surface and at least one protrusion provided in the back side region. The protrusion locally projects toward the first inner surface.

### TECHNICAL FIELD

The present disclosure relates to a female terminal, a connector and a wiring harness.

The present application claims a priority based on Japanese Patent Application No. 2019-237239 filed with the Japan Patent Office on Dec. 26, 2019, all the contents of which are hereby incorporated by reference.

### BACKGROUND

A male terminal and a female terminal are used as electrical connecting members as shown in FIG. 9 of Patent Document 1. The female terminal typically includes a spring piece and a tube portion for accommodating the spring piece. As the male terminal inserted through an opening end of the tube portion presses the spring piece, the spring piece biases the male terminal. As a result, the male terminal and the female terminal are electrically connected.

The spring piece of the male terminal described in patent literature 1 is formed by bending a strip material integrated with a plate material constituting the tube portion having a rectangular shape a plurality of times inside the tube portion. In particular, the strip material extends from an opening end of one peripheral wall part, out of four peripheral wall parts constituting the tube portion. The strip material is folded toward the inside of the tube portion from the opening end. The strip material is also folded toward the opening end at an intermediate position of the strip material. Further, a tip part of the strip material is bent toward the peripheral wall part facing the one peripheral wall part having the strip material. The spring piece formed of such a strip material is cantilevered and supported on the opening end of the peripheral wall part of the tube portion.

A female terminal including two spring pieces inside a tube portion is cited as another example. The two spring pieces are respectively cantilevered and supported on two peripheral wall parts facing each other, out of four peripheral wall parts constituting the tube portion in the form of a rectangular tube. The two spring pieces facing each other sandwich and bias a male terminal.

### PRIOR ART DOCUMENT

### Patent Document

Patent Document 1: JP 2004-311085 A

### SUMMARY OF THE INVENTION

### Problems to be Solved

The present disclosure is directed to a female terminal with a tube portion and a spring piece to be arranged inside the tube portion, wherein the tube portion has an opening end, a male terminal being inserted through the opening end, and a first inner surface and a second inner surface facing each other across the spring piece, the spring piece is cantilevered and supported on the first inner surface, the spring piece has a front side region configured to face the male terminal, a back side region to be arranged on the side of the first inner surface and at least one protrusion provided in the back side region, and the protrusion locally projects toward the first inner surface.

The present disclosure is directed to a connector with the female terminal of the present disclosure and a housing for holding the female terminal.

The present disclosure is directed to a wiring harness with the connector of the present disclosure and a wire to be connected to the female terminal.

### BRIEF DESCRIPTION OF THE DRAWINGS

FIG. 1 is a side view of a female terminal of a first embodiment when viewed from a direction orthogonal to an axial direction of a tube portion.

FIG. 2 is a section along II-II shown in FIG. 3 of the tube portion and a spring piece in the male terminal shown in FIG. 1.

FIG. 3 is a section along shown in FIG. 1 of the tube portion and a spring piece in the male terminal shown in FIG. 1.

FIG. 4 is a section enlargedly and schematically showing a region on a front surface side in the female terminal of the first embodiment.

FIG. 5 is a section of a tube portion and a spring piece cut by a plane orthogonal to an axial direction of the tube portion in a female terminal of a second embodiment.

FIG. 6 is a section of a tube portion and a spring piece cut by a plane orthogonal to an axial direction of the tube portion in a female terminal of a third embodiment.

FIG. 7 is a section of a tube portion and a spring piece cut by a plane orthogonal to an axial direction of the tube portion in a female terminal of a fourth embodiment.

FIG. 8 is a section of a tube portion and a spring piece cut by a plane orthogonal to an axial direction of the tube portion in a female terminal of a fifth embodiment.

FIG. 9 is a side view showing a connector of an embodiment and a wiring harness of the embodiment.

FIG. 10 is a graph showing a relationship of a contact load and a friction coefficient in test example 1.

FIG. 11 is a graph showing a relationship of a contact pressure and the friction coefficient in test example 1.

### DETAILED DESCRIPTION TO EXECUTE THE INVENTION

### Technical Problem

A female terminal into which a male terminal is easily inserted is desired.

The female terminal is typically used as an electrical connecting member in a female connector. In the case of connecting a female connector including a plurality of female terminals and a male connector including a plurality of male terminals, the respective male terminals are simultaneously inserted into the respective female terminals. Thus, if it is hard to insert each male terminal into each female terminal such as because a spring piece of each female terminal hinders the insertion of each male terminal, a force for connecting the male connector and the female connector tends to increase. As the number of the male terminals and the number of the female terminals increase, the above connecting force increases. Thus, a worker's burden increases in connecting the male connector and the female connector.

Accordingly, one object of the present disclosure is to provide a female terminal into which a male terminal is easily inserted. Another object of the present disclosure is to provide a connector and a wiring harness in which a male terminal is easily inserted.

### Effect of Present Disclosure

A female terminal of the present disclosure, a connector of the present disclosure and a wiring harness of the present disclosure are excellent in the insertability of a male terminal.

### Description of Embodiments of Present Disclosure

The present inventors acquired the following knowledge concerning a female terminal provided with a tube portion and a spring piece.

The spring piece is pressed toward, for example, an inner surface of a peripheral wall part, on which the spring piece is cantilevered and supported, out of peripheral wall parts constituting the tube portion, by a male terminal inserted into the tube portion. By this pressing, a location facing the inner surface in the spring piece contacts this inner surface. Further, as the male terminal advances in the tube portion, the location facing the inner surface in the spring piece slides on the inner surface. The spring piece is said to be less likely to hinder the insertion of the male terminal as a friction coefficient of the spring piece and the inner surface in this sliding state decreases. That is, the male terminal is easily inserted into the female terminal. Further, as a pressure applied when the location facing the inner surface in the spring piece contacts the inner surface increases, the friction coefficient tends to decrease. The female terminal of the present disclosure is based on the above knowledge. The above pressure, i.e. a pressure applied when the spring piece provided in the female terminal contacts the inner surface of the tube portion, may be called a contact pressure below.

First, embodiments of the present disclosure are listed and described.

(1) A female terminal according to one aspect of the present disclosure is provided with a tube portion and a spring piece to be arranged inside the tube portion, wherein the tube portion has an opening end, a male terminal being inserted through the opening end, and a first inner surface and a second inner surface facing each other across the spring piece, the spring piece is cantilevered and supported on the first inner surface, the spring piece has a front side region configured to face the male terminal, a back side region to be arranged on the side of the first inner surface and at least one protrusion provided in the back side region, and the protrusion locally projects toward the first inner surface.

The female terminal of the present disclosure can reduce a contact area of the spring piece and the first inner surface of the tube portion by the protrusion. The aforementioned contact pressure tends to increase as described later since the contact area is small. Thus, a friction coefficient of the spring piece and the first inner surface of the tube portion in inserting the male terminal into the tube portion tends to decrease. Since the male terminal is easily inserted into the tube portion, such a female terminal of the present disclosure is excellent in the insertability of the male terminal.

Further, since the friction coefficient of the protrusion and the first inner surface is small, the protrusion and the vicinity thereof easily slide on the first inner surface even if the spring piece is further pressed toward the first inner surface by the male terminal after the protrusion contacts the first inner surface. The spring piece does not substantially come into surface contact with the first inner surface, depending on the shape, the size and the like of the protrusion. Also from these points, the female terminal of the present disclosure is excellent in the insertability of the male terminal.

(2) As an example of the female terminal of the present disclosure, in a cross-section of the spring piece cut by a plane orthogonal to an axial direction of the tube portion, a direction orthogonal to both a facing direction of the first inner surface and the second inner surface and the axial direction is a width direction, the back side region has a location curved such that side edge parts in the width direction respectively approach the first inner surface and a central part in the width direction is separated from the first inner surface, and the protrusion includes the side edge part.

The above aspect includes two protrusions. Thus, the spring piece and the first inner surface of the tube portion tend to come into contact at two points. In this respect, the contact area tends to decrease. Further, in the above aspect, the two protrusions contact the first inner surface and a state where a location of the spring piece other than the protrusions does not contact the first inner surface is easily maintained. Thus, a state where the contact area is small is easily maintained.

(3) As an example of the female terminal of the present disclosure, in a cross-section of the spring piece cut by a plane orthogonal to an axial direction of the tube portion, a direction orthogonal to both a facing direction of the first inner surface and the second inner surface and the axial direction is a width direction, the back side region has a location curved such that side edge parts in the width direction are respectively separated from the first inner surface and a central part in the width direction approaches the first inner surface, and the protrusion includes the central part.

The above aspect includes one protrusion. Thus, the spring piece and the first inner surface of the tube portion come into contact at one point. In this respect, the contact area tends to decrease.

(4) As an example of the female terminal of (2) or (3) described above, the first inner surface has such a curved shape that a central part in the width direction of the first inner surface is separated from the second inner surface and side edge parts in the width direction of the first inner surface approach the second inner surface.

In the above aspect, the location other than the protrusion(s) is unlikely to contact the first inner surface in the back side region. Thus, the state where the contact area is small is easily maintained.

(5) As an example of the female terminal of the present disclosure, the protrusion has an embossed location.

The protrusion can have, for example, a point-contactable shape by embossing. Thus, the contact area tends to become smaller.

(6) As an example of the female terminal of the present disclosure, the female terminal has a base material and a plating layer at least partially covering a surface of the base material, a location covering the first inner surface and a location covering the protrusion, out of the plating layer, have surface layers made of the same type of material, and the material is one type of metal selected from a group consisting of pure tin, tin alloy, pure silver and silver alloy.

In the above aspect, the surface layer on the side of the first inner surface and the surface layer on the side of the protrusion are made of the material that easily adheres. However, since the contact pressure is high, the protrusion can break through the surface layer on the side of the first inner surface and contact a location inside this surface layer. As a result, adhesion is unlikely to occur. Thus, the above aspect easily prevents an increase in the friction coefficient due to adhesion.

(7) As an example of the female terminal of (6) described above, at least one of the location covering the first inner surface and the location covering the protrusion, out of the plating layer, is thinner than a location covering other than the first inner surface and the protrusion.

In the above aspect, adhesion is unlikely to occur between the first inner surface and the protrusion. Thus, the above aspect more easily prevents an increase in the friction coefficient due to adhesion.

(8) As an example of the female terminal of the present disclosure, the spring piece is constituted by a strip material bent into a predetermined shape and includes a base piece constituting the front side region and a tip piece constituting the back side region, the base piece extends toward inside of the tube portion from the opening end, the tip piece is folded toward the opening end from the base piece, and a ratio L1/L2 is 0.51 or less if L1 denotes a length of the tip piece and L2 denotes a length of the base piece.

In the above aspect, a spring constant of the spring piece tends to increase. Thus, a contact state with the male terminal can be satisfactorily maintained in the above aspect. Further, in the above aspect, the entire length of the strip material constituting the spring piece is short as compared to the case where the length of the base piece is equal and the ratio L1/L2 is more than 0.51. Thus, the above aspect is small in size and light in weight.

(9) As an example of the female terminal of the present disclosure, the spring piece is constituted by a strip material bent into a predetermined shape and includes a base piece constituting the front side region and a tip piece constituting the back side region, the base piece extends toward inside of the tube portion from the opening end, the tip piece is folded toward the opening end from the base piece, and a length of the tip piece is less than 2.4 mm.

In the above aspect, the entire length of the strip material constituting the spring piece is short as compared to the case where the length of the tip piece is 2.4 mm or more. Thus, the above aspect is small in size and light in weight.

(10) A connector according to one aspect of the present disclosure is provided with the female terminal of any one of (1) to (9) described above and a housing for holding the female terminal.

The connector of the present disclosure is excellent in the insertability of the male terminal. Particularly, if the connector of the present disclosure is a multipole connector including a plurality of female terminals, the connector of the present disclosure and a male connector are easily connected. Thus, a worker's burden can be reduced in connecting the connector of the present disclosure to the male connector.

(11) A wiring harness according to one aspect of the present disclosure is provided with the connector of (10) described above and a wire to be connected to the female terminal.

The wiring harness of the present disclosure is excellent in the insertability of the male terminal. Particularly, even if the connector provided in the wiring harness of the present disclosure is the aforementioned multipole connector, the connector of the present disclosure and a male connector are easily connected. Thus, a worker's burden can be reduced in connecting the wiring harness of the present disclosure to the male connector.

### Details of Embodiments of Present Disclosure

Hereinafter, embodiments of the present disclosure are described in detail with reference to the drawings. The same reference signs in figures denote the same components.

### First Embodiment

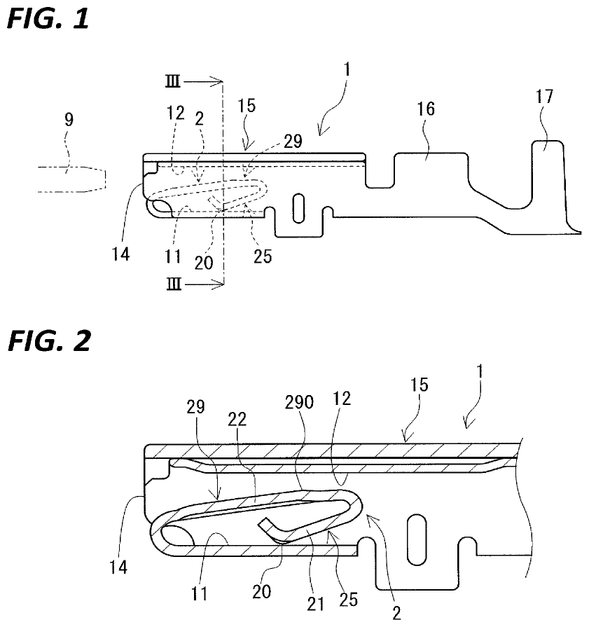

Hereinafter, a female terminal of a first embodiment is described with reference to FIGS. 1 to 4.

FIG. 1 is a view showing a state where the female terminal 1 of the first embodiment is arranged with a spring piece 2 cantilevered and supported by a tube portion 15 on a lower side when viewed from a direction orthogonal to an axial direction of the tube portion 15.

FIG. 2 is a longitudinal section of the tube portion 15 and the spring piece 2 cut by a plane parallel to the axial direction and a height direction to be described later in the female terminal 1 of the first embodiment. FIG. 2 shows a location of the tube portion 15 where the spring piece 2 is accommodated.

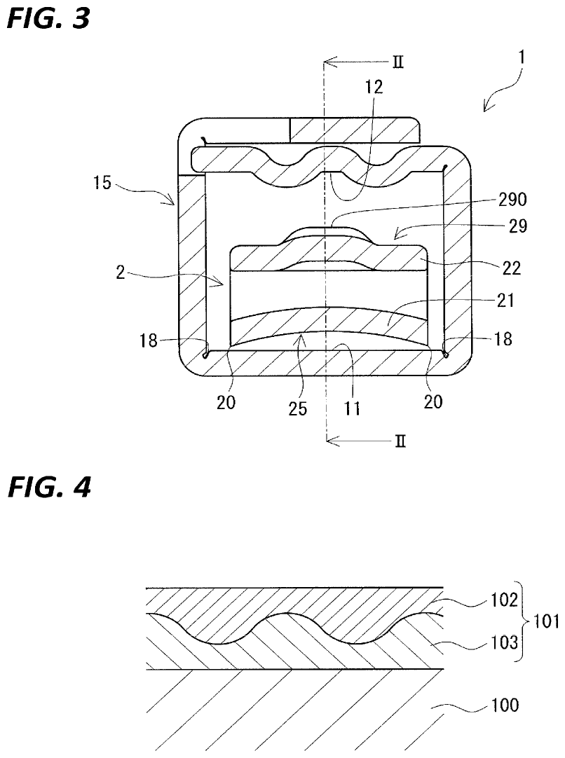

FIG. 3 is a lateral section of the tube portion 15 and the spring piece 2 cut by a plane orthogonal to the axial direction in the female terminal 1 of the first embodiment. FIG. 3 shows a location of the spring piece 2 where protrusions 20 are provided.

Note that any of FIGS. 1 to 3 and FIGS. 5 to 9 to be described later shows a state where a male terminal 9 is not inserted in the tube portion 15.

(Summary)

The female terminal 1 of the first embodiment includes the tube portion 15 and the spring piece 2 as shown in FIG. 1. The spring piece 2 is arranged inside the tube portion 15. The male terminal 9 is inserted into the tube portion 15. The male terminal 9 inserted into the tube portion 15 presses the spring piece 2 and the spring piece 2 biases the male terminal 9. A contact state of the female terminal 1 and the male terminal 9 is firmly held by a biasing force of the spring piece 2. Note that the male terminal 9 is virtually shown by a two-dot chain line in FIG. 1. Further, the male terminal 9 is typically a rod-like member.

In the female terminal 1 of the first embodiment, the spring piece 2 has a specific shape. Specifically, the spring piece 2 includes at least one protrusion 20 in a back side region 25 configured not to face the male terminal 9. The protrusion 20 locally projects toward a first inner surface 11, out of the inner surface of the tube portion 15 (FIG. 3). The first inner surface 11 is a surface on which the spring piece 2 is cantilevered and supported (FIG. 2). In the female terminal 1, the protrusion 20 serves as a contact location of the spring piece 2 with the first inner surface 11. In such a female terminal 1, a contact area of the spring piece 2 and the first inner surface 11 of the tube portion 15 can be reduced. This is described in more detail below.

(Basic Configuration)

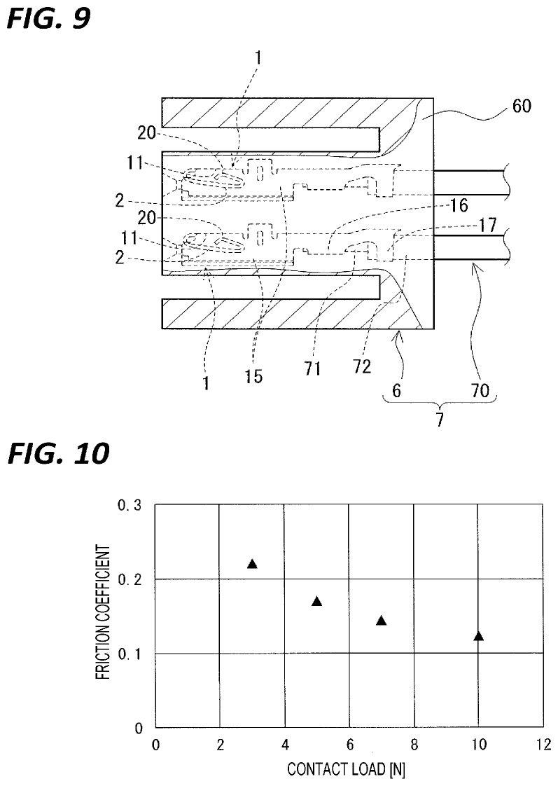

The female terminal 1 of the first embodiment is typically an electrically conductive member formed by bending a plate material having a predetermined shape into a specific shape. The female terminal 1 has a connecting location to the male terminal 9 and a connecting location to a wire 70 (FIG. 9 to be described later). Such a female terminal 1 is used as a member for electrically connecting an unillustrated printed wiring board or the like connected to the male terminal 9 and an unillustrated electronic/electric device connected to the wire 70.

The connecting location to the male terminal 9 includes one tube portion 15 and at least one spring piece 2. The tube portion 15 of this example is in the form of a rectangular tube having square end surface shape and lateral cross-sectional shape (FIG. 3). Further, the female terminal 1 of this example includes one spring piece 2.

The connecting location to the wire 70 typically includes a wire barrel portion 16 and an insulation barrel portion 17. FIG. 1 shows a state where the female terminal 1 is not holding the wire 70. In this state, strip pieces for wrapping around the wire 70 are not folded.

(Connecting Location to Male Terminal)

<Tube Portion>

The tube portion 15 of this example has four peripheral wall parts as shown in FIG. 3.

In this example, notches 18 serving as folding line are provided in a plate material before being bent. The notch 18 is a linear cut extending along the axial direction of the tube portion 15. The adjacent peripheral wall parts are bent to be substantially orthogonal by the notch 18. Thus, the adjacent peripheral wall parts are arranged to be substantially orthogonal. An angled part formed by the adjacent peripheral wall parts is substantially right-angled.

Further, the four peripheral wall parts include two pairs of the peripheral wall parts facing each other. Each peripheral wall part has a part constituted by a flat plate piece. In this example, the peripheral wall part on a left side, the peripheral wall part on a right side and the peripheral wall part on a lower side in FIG. 3 are substantially 1constituted by one flat plate piece. Although the peripheral wall part on an upper side is constituted by two overlapping plate pieces in FIG. 3, this peripheral wall part may be constituted by one plate piece. Further, in this example, out of the two plate pieces, the inner plate piece having a second inner surface 12 includes a bead portion projecting inwardly of the tube portion 15. The bead portion of this example is formed into a W shape. By including the bead portion, the male terminal 9 is positioned between two projections in the W shape. As a result, the contact state of the female terminal 1 and the male terminal 9 is stabilized.

The inner surfaces of the two facing peripheral wall parts also face each other. Specifically, the tube portion 15 has the first inner surface 11 and the second inner surface 12 facing each other. In FIG. 1 and the like, the first inner surface 11 is a lower surface and the second inner surface 12 is an upper surface. In this example, the first inner surface 11 is a substantially flat surface.

A facing direction of the first and second inner surfaces 11, 12 is referred to as the height direction below. The height direction is a vertical direction in FIGS. 1 to 3 and FIGS. 5 to 8 to be described later.

A direction orthogonal to both the height direction and the axial direction of the tube portion 15 is referred to as a width direction. The width direction is a facing direction of the two peripheral wall parts not having the first and second inner surfaces 11, 12, out of the four peripheral wall parts. Further, the width direction is a lateral direction in FIG. 3 and FIGS. 5 to 8 to be described later. The axial direction is a lateral direction in FIGS. 1 and 2.

Both ends of the tube portion 15 are open. As shown in FIG. 1, one end part of the tube portion 15 is an opening end 14 through which the male terminal 9 is inserted. The wire barrel portion 16 and the insulation barrel portion 17 extend from the peripheral wall part having the first inner surface 11 on the other end side of the tube portion 15.

<Spring Piece>

<<Overall Structure>>

The spring piece 2 is held between the first and second inner surfaces 11, 12 inside the tube portion 15. Thus, the spring piece 2 has a region arranged on the side of the first inner surface 11 and a region arranged on the side of the second inner surface 12. The region arranged on the side of the second inner surface 12 is a front side region 29 that faces the male terminal 9. The front side region 29 includes a contact point portion 290 to be brought into contact with the male terminal 9 (FIG. 2). The region arranged on the side of the first inner surface 11 is the back side region 25 that does not face the male terminal 9.

The spring piece 2 of this example is constituted by a strip material bent into a predetermined shape. In particular, as shown in FIG. 2, the spring piece 2 extends from the opening end 14 of the peripheral wall part having the first inner surface 11, out of the four peripheral wall parts. The spring piece 2 is configured by bending this strip material three times inside the tube portion 15. Such a spring piece 2 constituted by the strip material is cantilevered and supported on the opening end 14 of the first inner surface 11 of the tube portion 15, thereby being integrated with the tube portion 15.

In first bending, the strip material is folded toward the inside of the tube portion 15 from the opening end 14 of the tube portion 15. In second bending, the strip material is so folded toward the opening end 14 that a side facing the first inner surface 11 is placed inside a bend at an intermediate position of the strip material. In third bending, the strip material is bent from the side of the first inner surface 11 toward the second inner surface 12 at a position near the tip edge of the strip material. Note that press working or the like can be used in a bending operation.

The spring piece 2 of this example includes a base piece 22 and a tip piece 21. The base piece 22 constitutes the front side region 29. The tip piece 21 constitutes a part of the back side region 25.

In particular, the base piece 22 is a folded part formed by the first bending described above. Thus, the base piece 22 extends from the opening end 14 toward the inside of the tube portion 15. Further, the base piece 22 is arranged to intersect the first inner surface 11. In particular, the base piece 22 is inclined more away from the first inner surface 11, i.e. more toward the second inner surface 12 with distance from the connecting location to the opening end 14, i.e. a base end. Thus, an angled part formed by the second bending described above is arranged closer to the second inner surface 12 than an angled part formed by the first bending.

The tip piece 21 is a part folded from the base piece 22 toward the opening end 14 by the second bending described above. The tip piece 21 and the base piece 22 are arranged to overlap in the height direction (FIG. 3). Thus, the tip piece 21 does not contact the male terminal 9.

The tip edge of the spring piece 2 is arranged toward the second inner surface 12 by the third bending described above. The tip edge is arranged to face upward in FIG. 2.

Out of an angled part formed by the third bending, an outer angled part is arranged to face the first inner surface 11. Thus, this outer angled part also constitutes the back side region 25. Further, the outer angled part is also a location arranged in proximity to the first inner surface 11, out of the spring piece 2. That is, the outer angled part is a location having a short distance to the first inner surface 11.

<<Protrusions>>

The spring piece 2 of this example includes two protrusions 20 on the above outer angled part as shown in FIG. 3. In particular, in a lateral cross-section shown in FIG. 3, the back side region 25 has a location curved such that side edge parts in the width direction approach the first inner surface 11 and a central part in the width direction is separated from the first inner surface 11. That is, the back side region 25 has a location curved toward the second inner surface 12, i.e. a curved part convex upward in FIG. 3. The above outer angled part is this curved location. A ridge of the outer angled part is drawn as a curve convex upward. Each protrusion 20 includes each side edge part. A case where each protrusion 20 is each side edge is illustrated in FIG. 3.

In this example, the ridge constituting the above outer angled part is entirely curved to draw one arc. The angled part having such a curved shape is provided by forming the outer angled part to warp toward the second inner surface 12 after or simultaneously with the third bending. Further, this curved shape is more easily formed than shapes shown in fourth and fifth embodiments to be described later. In this respect, the female terminal 1 of this example is excellent in manufacturability.

<<Functions of Protrusions>>

Functions of the protrusions 20 are described in detail below.

The protrusions 20 are locations arranged closest to the first inner surface 11 in the spring piece 2. That is, the projections 20 are locations having a shortest distance to the first inner surface 11. Thus, if the male terminal 9 inserted into the tube portion 15 presses the spring piece 2 toward the first inner surface 11, only the protrusions 20 or only the protrusions 20 and the vicinities thereof contact the first inner surface 11 in the back side region 25. That is, the location other than the protrusions 20 is not in contact with the first inner surface 11 in the back side region 25 of the spring piece 2. In this state, a contact area of the spring piece 2 and the first inner surface 11 of the tube portion 15 is small as compared to the case where a spring piece and the first inner surface 11 are in surface contact.

Note that if the protrusions 20 are not provided on the angled part formed by the third bending, the ridge of the outer angled part is linear. Thus, as shown in FIG. 9 of patent literature 1, the outer angled part is in line or surface contact with the first inner surface.

In this example, the above outer angled part has the specific curved shape as described above and the protrusions 20 are constituted by the side edge parts of the spring piece 2 in the back side region 25. Thus, the spring piece 2 is in contact with or nearly in contact with the first inner surface 11 at two points by the both protrusions 20. Therefore, the above contact area is small. Further, the central part in the width direction of the outer angled part is unlikely to contact the first inner surface 11 even if the spring piece 2 is pressed toward the first inner surface 11 by the male terminal 9.

With the protrusions 20 and the vicinities thereof held in contact with the first inner surface 11, the contact area of the spring piece 2 with the first inner surface 11 of the tube portion 15 is about a contact area of the protrusions 20 with the first inner surface 11. Thus, a pressure applied to the first inner surface 11 by the protrusions 20, i.e. a contact pressure, is high as compared to the case where the protrusions 20 are in line or surface contact with the first inner surface 11. Since the contact pressure is high, a friction coefficient of the spring piece 2 and the first inner surface 11 tends to decrease in inserting the male terminal 9 into the tube portion 15.

Here, one of reasons why the friction coefficient increases is that the surface of the spring piece 2 and the first inner surface 11 are covered with a plating layer made of an easy adhesion material as described later. If the above contact pressure is large, the protrusions 20 can break through an easy adhesion layer and contact a location inside this layer. As a result, the protrusions 20 and the first inner surface 11 hardly adhere. Thus, an increase in friction coefficient due to adhesion is unlikely to occur. Consequently, the friction coefficient of the spring piece 2 and the first inner surface 11 tends to decrease.

Since the friction coefficient of the spring piece 2 and the first inner surface 11 is small, the contact locations of the spring piece 2 with the first inner surface 11, here mainly the protrusions 20, easily slide on the first inner surface 11. That is, the protrusions 20 are easily displaced to slide on the first inner surface 11 toward the opening end 14. As a result, if being pressed toward the first inner surface 11 by the male terminal 9, the spring piece 2 is easily resiliently deformed toward the first inner surface 11. Further, since the friction coefficient is small, the protrusions 20 and the vicinities thereof easily slide on the first inner surface 11 even if the spring piece 2 is further pressed by the male terminal 9. Thus, the spring piece 2 is easily resiliently deformed toward the first inner surface 11.

By the resilient deformation of the spring piece 2, a spacing between the front side region 29 of the spring piece 2 and the second inner surface 12 becomes wider. That is, an insertion location for the male terminal 9 becomes larger in the tube portion 15. Thus, the male terminal 9 is easily inserted into the tube portion 15 without being hindered by the spring piece 2.

In this example, the back side region 25 has the aforementioned curved location. Thus, even if the spring piece 2 is resiliently deformed toward the first inner surface 11, a state where the central part in the width direction is separated from the first inner surface 11 is easily maintained. Accordingly, the spring piece 2 is unlikely to be held in line or surface contact with the first inner surface 11. Preferably, the spring piece 2 is not substantially held in surface contact with the first inner surface 11. That is, a state where the spring piece 2 and the first inner surface 11 are in contact or nearly in contact at two points is easily maintained. Therefore, a state where the contact area of the spring piece 2 with the first inner surface 11 of the tube portion 15 is small is easily maintained. Also from these, the protrusions 20 easily slide on the first inner surface 11.

<<Specifications of Protrusions>>

The number of the protrusions 20, the shape of the protrusions 20, the size of the protrusions 20, the curved state of the back side region 25 and the like can be changed as appropriate within such a range that a large contact pressure can be secured by reducing the contact area of the spring piece 2 and the first inner surface 21 of the tube portion 15. Specific changes are described in second to fifth embodiments to be described later.

<<Miscellaneous>

A length of the base piece 22 and that of the tip piece 21 can be selected as appropriate.

The length of the base piece 22 is a length along an extending direction of the base piece 22 and a length from the angled part formed by the first bending to the angled part formed by the second bending.

The length of the tip piece 21 is a length along an extending direction of the tip piece 21 and a length from the angled part formed by the second bending to the angled part formed by the third bending.

For example, L1 and L2 denote the length of the tip piece 21 and that of the base piece 22. A ratio L1/L2 is, for example, 0.51 or less. If the ratio L1/L2 is 0.51 or less, a spring constant of the spring piece 2 tends to increase. Because of a large spring constant, the female terminal 1 tends to have a large contact load against the male terminal 9. Thus, the contact state of the female terminal 1 and the male terminal 9 is easily satisfactorily maintained. In the spring piece 2 having the ratio L1/L2 of 0.51 or less, an entire length of the strip material constituting the spring piece 2 is short as compared to a spring piece having the same length L2 and the ratio L1/L2 of more than 0.51. In this respect, the female terminal 1 is small in size and light in weight. Consequently, a connector 6 (FIG. 9) including the female terminals 1 tends to be small in size and light in weight. In terms of securing a contact state and reducing the size and weight, the ratio L1/L2 may be 0.50 or less or further 0.48 or less or 0.45 or less. The ratio L1/L2 may be 0.40 or less.

A lower limit of the ratio L1/L2 is not particularly determined. The lower limit of the ratio L1/L2 may be selected within such a range that the spring piece 2 satisfies a predetermined spring constant condition. For example, the ratio L1/L2 is 0.2 or more.

The length L1 of the tip piece 21 is, for example, less than 2.4 mm although depending on the size of the female terminal 1. If the size of the tube portion 15 is fixed, the entire length of the strip material constituting the spring piece 2 is short in the spring piece 2 having the length L1 of less than 2.4 mm as compared to the case where the length L1 is 2.4 mm or more. In this respect, the female terminal 1 is small in size and light in weight. Consequently, the connector 6 including the female terminals 1 tends to be small in size and light in weight. In terms of reducing the size and weight, the length L1 may be 2.2 mm or less or 2.0 mm or less although depending on the size of the female terminal 1.

The lower limit of the length L1 is, for example, 1.0 mm or more although depending on the size of the female terminal 1. The length L1 may be 1.5 mm or more.

The spring piece 2 may be such that the ratio L1/L2 is 0.51 or less and the length L1 is less than 2.4 mm. The female terminal 1 including such a spring piece 2 satisfactorily secures the contact state with the male terminal 9 and is small in size and light in weight. For example, if the tube portion 15 is in the form of a rectangular tube having square end surface shape and lateral cross-sectional shape, the tube portion 15 of the female terminal 1 including such a spring piece 2 is dimensioned such that a length of one side of the square shape is 3.0 mm.

(Connecting Location to Wire)

As shown in FIG. 9, the wire barrel portion 16 is electrically connected to a conductor 71 provided in the wire 70 by holding the conductor 71. The insulation barrel portion 17 holds an electrical insulation layer 72 provided in the wire 70.

Both the wire barrel portion 16 and the insulation barrel portion 17 include a base portion, on which the wire 70 is arranged, and a pair of strip pieces for wrapping around the wire 70. In this example, the base portion extends from the peripheral wall part having the first inner surface 11, out of the four peripheral wall parts constituting the tube portion 15. The pair of strip pieces extend from side edges of the base portion. With the female terminal 1 holding the wire 70, the pair of strip pieces facing each other are folded to wrap around the conductor 71 or the electrical insulation layer 72.

(Constituent Material)

The female terminal 1 typically has, as shown in FIG. 4, a base material 100 and plating layers 101 for at least partially covering a surface of the base material 100. FIG. 4 is a schematic section enlargedly showing a region near the surface of the female terminal 1. A plate material constituting the female terminal 1 is mainly made of the base material 100.

<Base Material>

A constituent material of the base material 100 is typically a pure copper or copper alloy.

The pure copper contains 99.9% by mass or more of Cu (copper) with the remainder being unavoidable impurities.

The copper alloy contains additive elements with the remainder being Cu and unavoidable impurities. The additive elements include, for example, Sn (tin), P (phosphor), Zn (zinc), Fe (iron), nickel (Ni) and silicon (Si). A total content of the additive elements is, for example, 0.05% by mass or more and 40% by mass or less. Specific examples of the copper alloy include phosphor bronze containing Sn and P, brass containing Zn and iron-containing copper containing Fe.

A thickness of the base material 100 is, for example, 0.1 mm or more and 1.5 mm or less although depending on the size of the female terminal 1. If the thickness is 1.0 mm or less or further 0.8 mm or less, the female terminal 1 is easily reduced in size.

<Plating Layer>

<<Summary>>

The plating layer 101 typically contributes to reducing a contact resistance with the male terminal 9. Thus, the female terminal 1 preferably includes the plating layer 101 at least at the connecting location to the male terminal 9. More specifically, the plating layers 101 are preferably provided in the front side region 29 of the spring piece 2, particularly the contact point portion 290 and the vicinity thereof, and a location of the second inner surface 12 facing the front side region 29.

The entire front and back surfaces of the base material 100 may have the plating layers 101. Such a female terminal 1 can be typically manufactured by using a coated plate material including a base material and a plating layer as a plate material before being bent into a predetermined shape. Plating layers having a uniform thickness are easily formed on front and back surfaces of the flat plate material before being bent. Thus, if the coated plate material is used, the female terminal 1 including the plating layers 101 on the entire front and back surfaces of the plate material constituting the base material 100 is manufactured with good productivity. The female terminal 1 of this example includes the plating layers 101 over the entire front and back surfaces of the plate material constituting the base material 100. That is, the plating layers 101 are provided also on the surface of the back side region 25 of the spring piece 2 and the surface of the first inner surface 11 in addition to the front side region 29 and the second inner surface 12.

<<Constituent Material>>

A constituent material of the plating layer 101 is, for example, a metal such as pure tin, tin alloy, pure silver, silver alloy, pure nickel and nickel alloy.

The pure tin contains 99% by mass or more of Sn (tin) with the remainder being unavoidable impurities. The pure tin may contain 99.8% by mass or more of Sn. The tin alloy contains additive elements with the remainder being Sn and unavoidable impurities. Specific examples of the tin alloy include an alloy containing tin and copper and an alloy containing tin and nickel. Zn and the like are cited as the additive elements other than Cu and Ni.

The pure silver contains 98% by mass or more of Ag (silver) with the remainder being unavoidable impurities. The pure silver may contain 98.5% by mass or more of Ag or 99.0% by mass or more of Ag. The silver alloy contains additive elements with the remainder being Ag and unavoidable impurities. A known composition can be used as the silver alloy.

The pure nickel contains 99% by mass or more of Ni (nickel) with the remainder being unavoidable impurities. The pure nickel may contain 99.9% by mass or more of Ni. The nickel alloy contains additive elements with the remainder being Ni and unavoidable impurities. The additive elements are, for example, Sn, Zn, Cu and the like.

The plating layer 101 may be a single layer or multi-layer. Particularly, a constituent material of a surface layer 102 including an outermost surface, out of the plating layer 101, is preferably one type of metal selected from a group consisting of pure tin, tin alloy, pure silver and silver alloy.

The pure tin is soft and easily deformed. Thus, the female terminal 1 having the surface layer 102 made of pure tin tends to have a low contact resistance with the male terminal 9.

The pure silver has a high electrical conductivity. Thus, the female terminal 1 having the surface layer 102 made of pure silver tends to have a low contact resistance with the male terminal 9.

The tin alloy is normally harder than the pure tin. The sliver alloy is normally harder than the pure silver. Thus, in the female terminal 1 having the surface layer 102 made of tin alloy or the surface layer 102 made of silver alloy, the male terminal 9 easily slides against the spring piece 2. As a result, the male terminal 9 is easily inserted into the tube portion 15.

In the female terminal 1 of this example, the plating layer 101 on the front surface side and the plating layer 101 on the back surface side of the plate material constituting the base material 100 are made of the same type of material. In this case, plating conditions are easily adjusted. Thus, the female terminal 1 having the plating layers 101 on the front and back surfaces of the plate material is manufactured with good productivity. In this example, the same type of material is the pure tin, out of four types of specific metals described above.

That is, in this example, a location covering the first inner surface 11 and a location covering the protrusions 20, out of the plating layer 101, have the surface layers 102 made of the same type of material. Here, among the four types of specific metals described above, the same type of metals easily adhere to each other. Thus, if the protrusions 20 contact the first inner surface 11, the surface layer 102 on the side of the protrusions 20 and the surface layer 102 on the side of the first inner surface 11 easily adhere to each other. However, in the female terminal 1 of the first embodiment, the contact pressure is high as described above. Thus, the protrusions 20 can break through the surface layer 102 on the side of the first inner surface 11 and contact a location inside this surface layer 102. This inner location is an inner layer 103 if the plating layer 101 is a multilayer, and is the base material 100 if the plating layer 101 is a single layer. Such a female terminal 1 can prevent an increase in the friction coefficient of the spring piece 2 and the first inner surface 11 due to adhesion.

<<Thickness>>

A thickness of the plating layer 101 can be selected as appropriate. For example, a total thickness of the plating layer 101 is 0.1 μm or more and 10 μm or less. A thickness of the surface layer 102 is, for example, 0.05 μm or more and 4.0 μm or less, or further 0.5 μm or more and 4.0 μm or less. If the plating layer 101 includes one or more inner layers 103, a thickness of each inner layer 103 is, for example, 0.05 μm or more and 1.0 μm or less, further 0.1 μm or more and 1.0 μm or less.

The thickness of the plating layer 101 may be substantially constant over the entire location provided with the plating layer 101, out of the base material 100. Alternatively, the thickness of the plating layer 101 may be partially different. For example, at least one of the location covering the first inner surface 11 and the location covering the protrusions 20, out of the plating layer 101, is thinner than a location covering other than the first inner surface 11 and the protrusions 20, out of the plating layer 101. In this case, if the protrusions 20 contact the first inner surface 11, the protrusions 20 easily contact the location inside the surface layer 102. Thus, an increase in the friction coefficient of the spring piece 2 and the first inner surface 11 due to adhesion is more easily prevented.

Note that the first inner surface 11 and the protrusions 20 do not contact the male terminal 9. Thus, that the thickness of the plating layer 101 is small on the first inner surface 11 and the protrusions 20 does not affect a reduction in contact resistance and the like. Therefore, one or both of the first inner surface 11 and the protrusions 20 may not have the plating layer 101.

To make the thickness of the plating layer 101 partially different, the plating layer 101 is, for example, partially squeezed and thinned by press working during bending. Alternatively, a thin plating layer 101 is partially formed, using masking or the like.

<<Miscellaneous>>

In this example, the plating layer 101 has a multilayer structure including the surface layer 102 and the inner layer 103. The inner layer 103 is made of alloy containing tin and copper. That is, the plating layers 101 including the surface layer 102 made of pure tin and the inner layer 103 made of the above alloy are provided in the front side region 29 and on the second inner surface 12. Such a female terminal 1 can reduce a contact resistance with the male terminal 9 by the surface layers 102 and, in addition, is excellent in the insertability of the male terminal 9 by the presence of the inner layers 103.

Besides, the plating layer 101 may include an unillustrated underlayer immediately above the base material 100. A constituent material of the underlayer is, for example, nickel, pure nickel alloy or the like.

Known conditions and the like can be referred to for manufacturing conditions of the plating layer 101. The plating layer 101 having the above multilayer structure is, for example, manufactured by applying a heating treatment after a layer made of pure tine is formed. By alloying Cu in the base material and Sn in the pure tin layer by the heating treatment, the inner layer 103 made of alloy containing tin and copper is obtained.

(Main Effects)

The female terminal 1 of the first embodiment can reduce the contact area of the spring piece 2 and the first inner surface 11 of the tube portion 15 by including the protrusions 20 in the back side region 25 of the spring piece 2. Since the contact area is small, the contact pressure is enhanced. Thus, even if the protrusions 20 and the first inner surface 11 have the surface layers 102 that easily adhere, the friction coefficient of the spring piece 2 and the first inner surface 11 tends to decrease. In such a female terminal 1 of the first embodiment, since the male terminal 9 is easily inserted into the tube portion 15, the insertability of the male terminal 9 is excellent.

Since the female terminal 1 of this example has the aforementioned specific curved location in the back side region 25, the spring piece 2 and the first inner surface 11 easily contact at two points. Further, in the curved location, the central part in the width direction hardly contacts the first inner surface 11. Since the contact area tends to decrease and, in addition, a state where the contact area is small is easily maintained, the female terminal 1 of the first embodiment is excellent in the insertability of the male terminal 9.

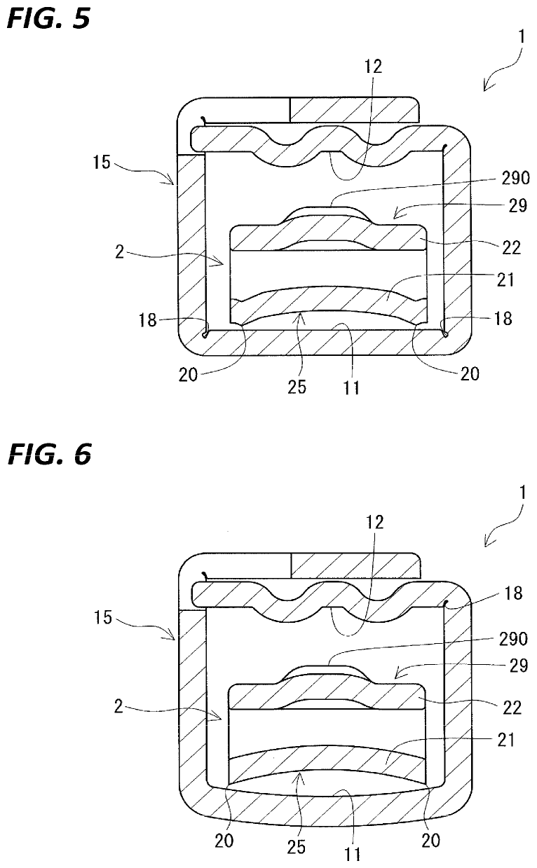

Female terminals of second to fifth embodiments are described below with reference to FIGS. 5 to 8.

Similarly to FIG. 3 described above, any of FIGS. 5 to 8 is a lateral section of a tube portion 15 and a spring piece 2 cut by a plane orthogonal to an axial direction of the tube portion 15. FIGS. 5 to 8 show a part of the spring piece 2 where protrusion(s) 20 is/are provided.

The female terminals 1 of the second to fifth embodiments have a basic configuration similar to that of the female terminal 1 of the first embodiment, and include the tube portion 15 and the spring piece 2 having the protrusion(s) 20.

The following description is centered on points of difference from the first embodiment, and configuration, effects and the like overlapped with the first embodiment are not described in detail.

### Second Embodiment

The female terminal of the second embodiment is described below with reference to FIG. 5.

In the female terminal 1 of the second embodiment, the protrusions 20 include embossed locations.

If embossing is used, the protrusions 20 are, for example, formed to have a point-contactable shape. The shape of the protrusions 20 is, for example, a conical shape or pyramidal shape. By such protrusions 20, the spring piece 2 easily comes into point contact with a first inner surface 11 of the tube portion 15. Further, by applying embossing to regions near widthwise side edge parts on the aforementioned outer angled part, the regions near the side edge parts tend to locally become harder by work hardening. Thus, even if the spring piece 2 is pressed toward the first inner surface 11 by the male terminal 9, the protrusions 20 are hardly deformed, with the result that the central part in the width direction is unlikely to contact the first inner surface 11. Therefore, the female terminal 1 of the second embodiment can reduce a contact area of the spring piece 2 and the first inner surface 11 of the tube portion 15. Further, the female terminal 1 of the second embodiment easily maintains a state where the contact area is small.

### Third Embodiment

The female terminal of the third embodiment is described below with reference to FIG. 6.

The female terminal 1 of the third embodiment does not include notches 18 between a peripheral wall part having a first inner surface 11 and peripheral wall parts adjacent to the former peripheral wall part. The peripheral wall part having the first inner surface 11 is constituted not by a flat plate piece, but by a curved plate piece. The first inner surface 11 is so curved that a central part in the width direction thereof is separated from a second inner surface 12 and side edge parts in the width direction thereof approach the second inner surface 12. The first inner surface 11 is curved to be convex downward in FIG. 6.

In this example, a ridge of the outer angled part including the protrusions 20 has a curved shape convex toward the second inner surface 12 in a back side region 25 of the spring piece 2. That is to say, the ridge of the outer angled part is curved toward a side opposite to the first inner surface 11. Thus, each protrusion 20 easily comes into point contact with the first inner surface 11. Further, in the back side region 25 of the spring piece 2, a location other than the protrusions 20 is unlikely to contact the first inner surface 11. Thus, a state where the spring piece 2 and the first inner surface 11 are in contact or nearly in contact at two points is easily maintained. Therefore, the female terminal 1 of the third embodiment can reduce a contact area of the spring piece 2 and the first inner surface 11 of the tube portion 15. Further, the female terminal 1 of the third embodiment easily maintains a state where the contact area is small.

### Fourth Embodiment

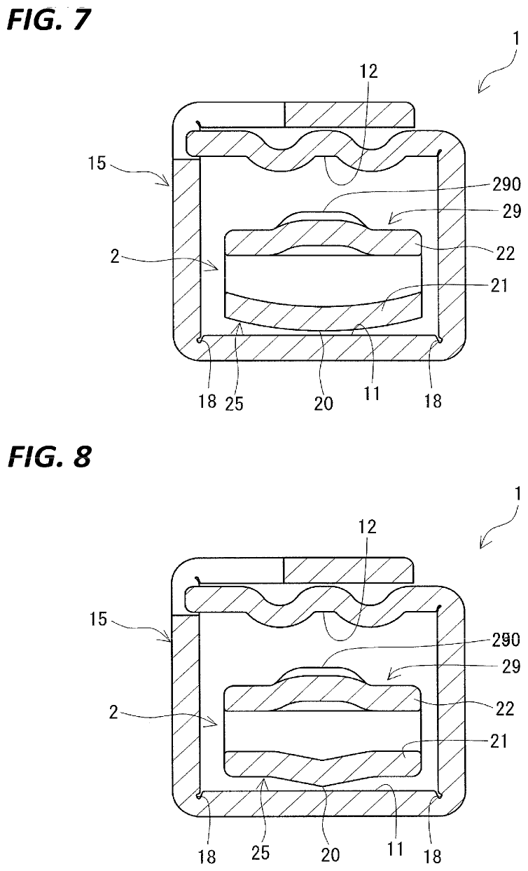

The female terminal of the fourth embodiment is described below with reference to FIG. 7.

In the female terminal 1 of the fourth embodiment, a ridge of the above outer angled part including the protrusion 20 has a curved shape convex toward a first inner surface 11 in a back side region 25 of the spring piece 2. That is to say, the ridge of the outer angled part is curved toward a side opposite to that in the first embodiment. In particular, the back side region 25 has a location curved such that side edge parts in the width direction are respectively separated from the first inner surface 11 and a central part in the width direction approaches the first inner surface 11 in a lateral cross-section of the spring piece 2 as shown in FIG. 7. The outer angled part is the curved location. The ridge of the outer angled part is drawn as a curve convex downward in FIG. 7. The protrusion 20 includes the central part in the width direction.

The female terminal 1 of the fourth embodiment includes one protrusion 20. Thus, the spring piece 2 and the first inner surface 11 easily come into contact at one point. Therefore, the female terminal 1 of the fourth embodiment can further reduce a contact area of the spring piece 2 and the first inner surface 11 of the tube portion 15.

### Fifth Embodiment

The female terminal of the fifth embodiment is described below with reference to FIG. 8.

In the female terminal 1 of the fifth embodiment, the protrusion 20 includes an embossed location as compared to the female terminal 1 of the fourth embodiment. The shape of the protrusion 20 is, for example, a conical shape or pyramidal shape. As described in the second embodiment, the protrusion 20 having a point-contactable shape is formed, using embossing. By such a protrusion 20, the spring piece 2 and a first inner surface 11 of the tube portion 15 easily come into point contact. Therefore, the female terminal 1 of the fifth embodiment can further reduce a contact area of the spring piece 2 and the first inner surface 11 of the tube portion 15.

### Sixth Embodiment

A female terminal 1 of a sixth embodiment includes one tube portion 15 and two spring pieces 2. The sixth embodiment is not shown.

The two spring pieces 2 are arranged to face each other inside the tube portion 15. Out of the two spring pieces 2, the first spring piece 2 is cantilevered and supported on a peripheral wall part having a first inner surface 11 as in the first embodiment and the like. The second spring piece 2 is cantilevered and supported on a peripheral wall part having a second inner surface 12. In a longitudinal section of the female terminal 1 of the sixth embodiment cut by a plane parallel to an axial direction and a height direction of the tube portion 15, the first and second spring pieces 2 are line-symmetrically shaped with respect to an axis of the tube portion 15 serving as a center.

Front side regions 29 of the respective spring pieces 2 are arranged to face each other inside the tube portion 15. The front side regions 29 of the both spring pieces 2 contact a male terminal 9 inserted into the tube portion 15. Further, if the male terminal 9 presses the two spring pieces 2, a back side region 25 of the first spring piece 2 approaches the first inner surface 11. A back side region 25 of the second spring piece 2 approaches the second inner surface 12.

The back side region 25 of the first spring piece 2 is arranged to face the first inner surface 11 inside the tube portion 15. Protrusion(s) 20 is/are provided in the back side region 25 as in the first embodiment and the like. Thus, if the male terminal 9 presses the two spring pieces 2 as described above, the protrusion(s) 20 of the first spring piece 2 contact(s) the first inner surface 11. Preferably, the protrusion(s) 20 come(s) into point contact with the first inner surface 11.

The back side region 25 of the second spring piece 2 is arranged to face the second inner surface 12 inside the tube portion 15. The second spring piece 2 also includes protrusion(s) 20 in the back side region 25. Thus, if the male terminal 9 presses the two spring pieces 2 as described above, the protrusion(s) 20 of the second spring piece 2 contact(s) the second inner surface 12. Preferably, the protrusion(s) 20 come(s) into point contact with the second inner surface 12.

Note that the first to fifth embodiments may be referred to for the basic configuration of the female terminal 1, the shape of the protrusion(s) 20 and the like.

The female terminal 1 of the sixth embodiment can reduce a contact area of the first spring piece 2 and the first inner surface 11 of the tube portion 15 and a contact area of the second spring piece 2 and the second inner surface 12 of the tube portion 15 by including the protrusion(s) 20 in the back side region 25 of each spring piece 2. Since the contact areas are small, the aforementioned contact pressure is enhanced. Thus, even if the protrusions 20, the first inner surface 11 and the second inner surface 12 have the aforementioned surface layers 102 that easily adhere, a friction coefficient of the first spring piece 2 and the first inner surface 11 and a friction coefficient of the second spring piece 2 and the second inner surface 12 tend to decrease. In such a female terminal 1 of the sixth embodiment, the male terminal 9 is easily inserted into the tube portion 15 and the insertability of the male terminal 9 is excellent.

[Connector]

Next, the connector of an embodiment is described with reference to FIG. 9.

The connector 6 of the embodiment includes the above female terminals 1 and a housing 60. The female terminal 1 may be any one of the above first to sixth embodiments. Note that a part of the housing 60 is shown cut away in FIG. 9.

The housing 60 is briefly described below.

The housing 60 is typically a molded body made of resin composition. Further, the housing 60 is an integrated object including a body portion and a receptacle. The body portion is a block-like part for holding the female terminals 1. The receptacle is a part in the form of a bottomed tube provided to cover the outer periphery of the body portion. A receptacle of a male connector including the male terminals 9 is fit between the outer peripheral surface of the body portion and the inner peripheral surface of the receptacle. The male connector is not shown.

The connector 6 typically includes a plurality of the female terminals 1 in one housing 60. Although the connector 6 includes two female terminals 1 in FIG. 9, the number of the female terminals 1 can be changed as appropriate.

A thermoplastic resin is cited as an example of a resin mainly contained in the resin composition. The thermoplastic resin is, for example, a polybutylene terephthalate (PBT), polyethylene terephthalate (PET), polystyrene (PS), polycarbonate (PC) or the like. The resin composition may contain various fillers in addition to the resin as a main component. The filler is, for example, glass fibers.

[Wiring Harness]

Next, a wiring harness of the embodiment is described with reference to FIG. 9.

The wiring harness 7 of the embodiment includes the connector 6 of the embodiment and the wires 70. The wires 70 are connected to the female terminals 1.

The wires 70 are briefly described below.

The wire 70 includes the conductor 71 and the electrical insulation layer 72. The electrical insulation layer 72 covers the outer periphery of the conductor 71.

The conductor 71 is typically a wire material made of an electrically conductive material such as copper, aluminum or alloys of these.

The electrical insulation layer 72 is typically made of an electrically insulating material such as a resin.

(Main Effects)

The female terminal 1 provided in the connector 6 of the embodiment and the wiring harness 7 of the embodiment includes the spring piece 2 having the protrusion(s) 20 as described above. Since the contact area of the spring piece 2 and the first inner surface 11 of the tube portion 15 is small, the male terminal 9 is easily inserted into the female terminal 1. Thus, even if the connector 6 includes the plurality of female terminals 1, the female connector 6 and the male connector including the plurality of male terminals 9 are easily connected. Therefore, a worker's burden is reduced in connecting the female connector 6 and the male connector.

[Test Example 1]

A relationship of a friction coefficient of a spring piece and an inner surface of a tube portion provided in a female terminal and a pressure applied when the spring piece contacts the inner surface, i.e. a contact pressure, was examined as follows.

(Description of Specimens)

The friction coefficient was measured using the following embossed piece and flat piece.

The embossed piece and the flat piece are both made of a coated plate material having a base material and a plating layer.

The base material is a commercially available copper alloy plate used as a base material of female terminals. This copper alloy has a composition of 1.8% Cu, 0.4% Ni, 1.1% Si, 0.1% Zn. The contents of additive elements are in % by mass.

The base material is a rectangular flat plate. A width of the base material is 40 mm. A length of the base material is 25 mm. A thickness of the base material is 0.25 mm.

The plating layer has a surface layer and an inner layer. The surface layer is made of pure tin. The inner layer is made of alloy containing tin and copper. The plating layer was formed under known conditions. A total thickness of the plating layer is 1.0 μm.

The embossed piece simulates a spring piece. The flat piece simulates an inner surface of a tube portion.

The embossed piece includes a hemispherical projection in a central part. A radius R of the projection is 1.0 mm. The projection was formed by press working the coated plate material.

The flat piece is a test piece using the coated plate material as it is. The flat piece is a flat plate material to which no special processing is applied.

(Measurement of Friction Coefficient)

A sliding test is conducted using the above embossed piece and flat piece. The friction coefficient is measured by this sliding test. The friction coefficient here is a dynamic friction coefficient. Note that the sliding test is conducted after the surface of the embossed piece and the surface of the flat piece are cleaned with acetone.

<<Conditions of Sliding Test>>

The sliding test is conducted under the following conditions, using a commercially available friction abrasion testing machine.

The friction abrasion testing machine is Tribometer CETRUMT-2 produced by Brucker.

A contact load is selected from a range of 3 N to 10 N.

A sliding speed is 0.2 mm/sec.

A sliding distance is 5 mm.

With the contact load selected from the above range applied to the embossed piece, the projection of the embossed piece is brought into contact with the flat piece. In this contact state, the flat piece is caused to slide the above sliding distance in one direction at the above sliding speed.

A maximum resistance force during sliding is measured by the friction abrasion testing machine. The dynamic friction coefficient is obtained by dividing the measured maximum friction force by the contact load.

(Calculation of Contact Pressure)

The contact pressure (MPa) is calculated from Hertz equation, using the contact load (N).

A maximum contact surface pressure P₀ when an arbitrary curved surface body having principal radii of curvature R₁₀, R₁₁ and an arbitrary curved surface body having principal radii of curvature R₂₀, R₂₁ contact in such a manner that an angle between surfaces having principal curvatures 1/R₁₀, 1/R₂₀ is ϕ is expressed as follows from the Hertz equation. The angle ϕ is an angle between major axes of the respective surfaces. Here, the angle ϕ is 0°.

P₀=(3P)/(2πab)

a=α×{(3/4)×(P/AE*)}^{1/3}

b=β×{(3/4)×(P/AE*)}^{1/3}

1/E*={(1/v₂²)/E₁}+{(1−v₂²)/E₂}

A=(1/2)×(1/R+1/R₁₁+1/R₂₀+1/R₂₁)

B=(1/2)×{(1/R₁₀−R₁₁)²+(1/R₂₀−1/R₂₁)²+X}^{1/2}

X=2×{(1/R₁₀1/R₁₁)×(1/R₂₀−1/R₂₁)cos2ϕ}^{1/2}

R₁₀, R₁₁ are radii of curvature of the embossed piece here. R₁₀=R₁₁=1 mm.

R₂₀, R₂₁ are radii of curvature of the flat piece here. The flat piece is assumed to have a very large curvature. R₂₀=R₂₁=10¹¹ mm.

P is the contact load (N).

a, b are respectively a major axis radius (mm) and a minor axis radius (mm) of an elliptical contact surface in a semi-elliptical distribution based on the above curved surface body.

α, β are parameters determined by the radii of curvature and the angle ϕ. α, β are determined by cosθ=B/A. Here, since R₂₀=R₂₁=10¹¹ mm, B=0. Therefore, θ=90°. α, β in this case are: α=β=1.0.

v1, v2 are Poisson's ratios of pure tin constituting the surface layer here. v1 =v2=0.36.

E₁, E₂ are Young's moduli of pure tin constituting the surface layer here. E₁=E₂=50 GPa.

FIG. 10 is a graph showing a relationship of the contact load (N) and the friction coefficient. A horizontal axis represents the contact load (N). A vertical axis represents the friction coefficient.

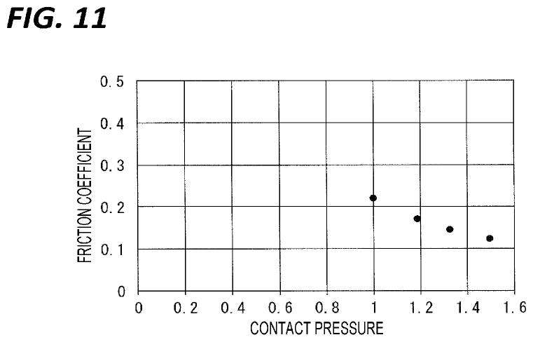

FIG. 11 is a graph showing a relationship of the contact pressure and the friction coefficient. A horizontal axis represents the contact pressure. Here, a minimum contact pressure (MPa) serves as a reference and other contact pressures are represented by relative values. A vertical axis represents the friction coefficient.

As shown in FIG. 10, it is understood that the friction coefficient decreases as the contact load (N) increases. Further, as shown in FIG. 11, it is understood that the friction coefficient decreases as the contact pressure (MPa) increases. The friction coefficient is considered to decrease as the contact pressure (MPa) increases for the following reason. The embossed piece and the flat piece have the surface layers that easily adhere. However, since the contact pressure (MPa) is large, the surface layer of the flat piece is broken through when the projection of the embossed piece contacts the flat piece. As a result, the projection could contact the inner layer or the base material inside the surface layer of the flat piece.

From these graphs, it is said to be effective to have a large contact pressure (MPa) in order to reduce the friction coefficient. It is also said to be effective to have a large contact load (N) in order to increase the contact pressure (MPa). Further, it is said to be effective to reduce the contact area of the spring piece and the inner surface of the tube portion in order to increase the contact load (N).

It was shown from the above test that the pressure applied when the spring piece contacted the inner surface, i.e. the contact pressure, was enhanced since the contact area of the spring piece and the inner surface of the tube portion was small in the female terminal. Further, it was shown that the friction coefficient of the spring piece and the inner surface of the tube portion decreased due to a high contact pressure when the male terminal was inserted into the tube portion of the female terminal even if the spring piece and the inner surface had the surface layers that easily adhered to each other. The male terminal is easily inserted into the female terminal having a small friction coefficient.

The present invention is not limited to these illustrations and is intended to be represented by claims and include all changes in the scope of claims and in the meaning and scope of equivalents.

For example, the following changes can be made in the female terminals 1 of the above embodiments.

(1) In the female terminals 1 of the second, fourth and fifth embodiments, the first inner surface 11 is not the flat surface described in the first embodiment, but has the curved shape described in the third embodiment.

(2) The spring piece 2 has a chevron-shaped structure in which the strip material extending from the peripheral wall part constituting the tube portion 15 is bent twice instead of a winding structure in which the strip material is bent three times. Alternatively, the spring piece 2 has a structure in which the strip material is bent once. When being pressed by the male terminal, the tip edge of the spring piece contacts the inner surface of the tube portion in these spring pieces. Further, as the male terminal advances, the tip edge slides toward a side away from the opening end of the tube portion.

(3) The spring piece 2 is constituted not by the strip material, but by a metal piece joined to the first inner surface 11 of the tube portion 15. In the case of the metal piece, welding or the like can be used. Further, the metal piece before joining is, for example, formed with the protrusion(s) 20.

### LIST OF REFERENCE NUMERALS

1 female terminal
11 first inner surface, 12 second inner surface, 14 opening end
15 tube portion, 16 wire barrel portion, 17 insulation barrel portion
18 notch
100 base material, 101 plating layer, 102 surface layer, 103 inner layer
2 spring piece
20 protrusion, 21 tip piece, 22 base piece
25 back side region, 29 front side region, 290 contact point portion
6 connector, 60 housing
7 wiring harness, 70 wire, 71 conductor, 72 electrical insulation layer
9 male terminal

1. A female terminal, comprising:
a tube portion; and
a spring piece to be arranged inside the tube portion,
wherein:
the tube portion has an opening end, a male terminal being inserted through the opening end, and a first inner surface and a second inner surface facing each other across the spring piece,
the spring piece is cantilevered and supported on the first inner surface,
the spring piece has a front side region configured to face the male terminal, a back side region to be arranged on the side of the first inner surface and at least one protrusion provided in the back side region, and
the protrusion locally projects toward the first inner surface.

2. The female terminal of claim 1, wherein, in a cross-section of the spring piece cut by a plane orthogonal to an axial direction of the tube portion,
a direction orthogonal to both a facing direction of the first inner surface and the second inner surface and the axial direction is a width direction,
the back side region has a location curved such that side edge parts in the width direction respectively approach the first inner surface and a central part in the width direction is separated from the first inner surface, and
the protrusion includes the side edge part.

3. The female terminal of claim 1, wherein, in a cross-section of the spring piece cut by a plane orthogonal to an axial direction of the tube portion,
a direction orthogonal to both a facing direction of the first inner surface and the second inner surface and the axial direction is a width direction,
the back side region has a location curved such that side edge parts in the width direction are respectively separated from the first inner surface and a central part in the width direction approaches the first inner surface, and
the protrusion includes the central part.

4. The female terminal of claim 2, wherein:
the first inner surface has such a curved shape that a central part in the width direction of the first inner surface is separated from the second inner surface and side edge parts in the width direction of the first inner surface approach the second inner surface.

5. The female terminal of claim 1, wherein the protrusion has an embossed location.

6. The female terminal of claim 1, comprising a base material and a plating layer at least partially covering a surface of the base material, wherein:
a location covering the first inner surface and a location covering the protrusion, out of the plating layer, have surface layers made of the same type of material, and
the material is one type of metal selected from a group consisting of pure tin, tin alloy, pure silver and silver alloy.

7. The female terminal of claim 6, wherein at least one of the location covering the first inner surface and the location covering the protrusion, out of the plating layer, is thinner than a location covering other than the first inner surface and the protrusion.

8. The female terminal of claim 1, wherein:
the spring piece is constituted by a strip material bent into a predetermined shape and includes a base piece constituting the front side region and a tip piece constituting the back side region,
the base piece extends toward inside of the tube portion from the opening end,
the tip piece is folded toward the opening end from the base piece, and
a ratio L1/L2 is 0.51 or less if L1 denotes a length of the tip piece and L2 denotes a length of the base piece.

9. The female terminal of claim 1, wherein:
the spring piece is constituted by a strip material bent into a predetermined shape and includes a base piece constituting the front side region and a tip piece constituting the back side region,
the base piece extends toward inside of the tube portion from the opening end,
the tip piece is folded toward the opening end from the base piece, and
a length of the tip piece is less than 2.4 mm.

10. A connector, comprising:
the female terminal of claim 1; and
a housing for holding the female terminal.

11. A wiring harness, comprising:
the connector of claim 10; and
a wire to be connected to the female terminal.
